(19) United States
(12) Patent Application Publication
(10) Pub. No.: US 2025/0100667 A1
(43) Pub. Date: Mar. 27, 2025

(54) LUBRICATION MECHANISM

(71) Applicant: HONDA MOTOR CO., LTD., Tokyo (JP)

(72) Inventor: Naotoshi Nio, Wako-shi (JP)

(21) Appl. No.: 18/475,431

(22) Filed: Sep. 27, 2023

(51) Int. Cl. B63H 21/38; F01M 11/02; F16C 3/02

(52) U.S. Cl. CPC B63H 21/386; F01M 11/02; F16C 3/02; F16C 2326/30

(57) ABSTRACT

A rotating shaft is formed in a hollow shape with lubrication oil conducted inside, a lubrication oil auxiliary plate is provided on the rotating shaft, and a lubrication oil passage to the lubrication oil auxiliary plate is formed from a center of the rotating shaft.

### BACKGROUND OF THE INVENTION

### Field of the Invention

The present invention relates to a lubrication mechanism.

### Description of the Related Art

Conventionally, a technique of scattering oil by an operation of an oil slinger, a technique for lubricating within oil, a technique for sending oil by a pump and the like are known as supply techniques of lubrication oil. For example, Japanese Patent Laid-Open No. 2007-314045 discloses a technology for forcibly pressure-feeding oil by an oil pump.

However, since lubrication by an oil slinger is a supply of lubrication oil by scattering, the lubrication efficiency is bad. Since lubrication-in-oil has an increase in friction, the lubrication efficiency decreases. Therefore, there is a problem in which forcibly pressure-feeding oil by an oil pump results in an oil conveying passage that is complex.

The present invention takes into consideration the above-stated circumstances, and has an objective of providing a lubrication mechanism that can supply lubrication oil, without lowering the efficiency, by a simple lubrication mechanism.

### SUMMARY OF THE INVENTION

In order to achieve this objective, one aspect of the present invention is a lubrication mechanism in which a rotating shaft is formed in a hollow shape with lubrication oil conducted inside, a lubrication oil auxiliary plate is provided on the rotating shaft, and a lubrication oil passage to the lubrication oil auxiliary plate is formed from a center of the rotating shaft.

According to the present invention, by supplying lubrication oil to a lubrication oil auxiliary plate, lubrication oil can be scattered by a centrifugal force, and lubrication oil can be supplied to distant members.

### BRIEF DESCRIPTION OF THE DRAWINGS

FIG. 1 is a side view of an outboard motor in an embodiment of the present invention;

FIG. 2 is a side view of a power reduction gear and a steering reduction gear;

FIG. 3 is a perspective view of the power reduction gear and the steering reduction gear;

FIG. 4 is a perspective view of a rotary lubrication mechanism; and

FIG. 5 is a top view of the rotary lubrication mechanism.

### DETAILED DESCRIPTION OF THE PREFERRED EMBODIMENTS

### Configuration of an Outboard Motor Relating to an Embodiment

An embodiment of the present invention will be described with reference to the figures. Note that, in the present embodiment, an example of a case where a lubrication mechanism is applied to a lubrication mechanism of an outboard motor will be described.

Note that, within the description, descriptions of directions such as front-rear, left-right, and up-down will be the same as front-rear and left-right with respect to a traveling direction of a ship hull, unless otherwise specified.

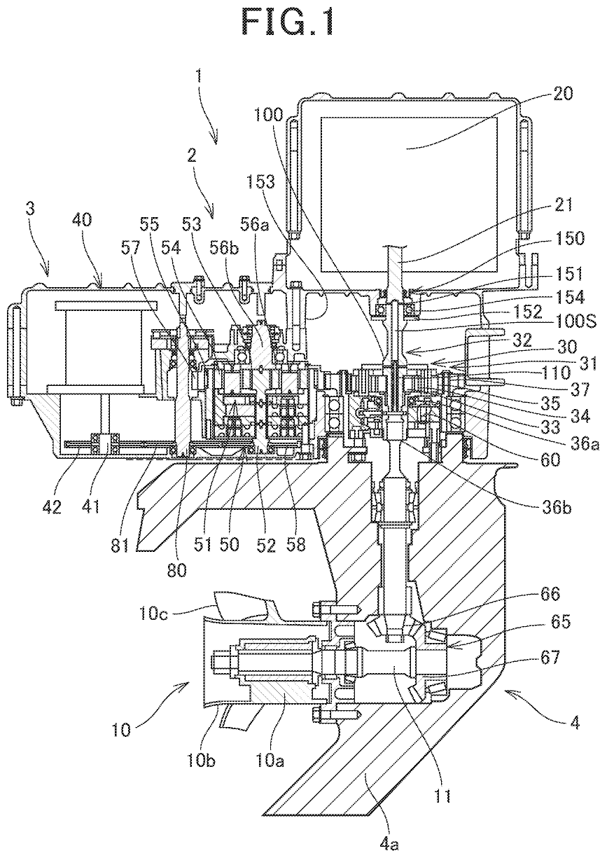

FIG. 1 is a side view of an outboard motor 1 relating to an embodiment of the present invention. The outboard motor 1 has a body case 2, a power motor 20 supported above the body case 2, and a propeller 10.

The body case 2 has a hollow structure made of a metallic material or a resin material.

The body case 2 includes an upper case 3 and a lower case 4.

The power motor 20 is arranged above a front part of the body case 2, so that an output shaft 21 of the power motor 20 extends in an up-down direction.

The upper case 3 forms a substantially rectangular shape that extends in a front-rear direction when seen in a side view. A power reduction gear 30 is housed inside the upper case 3, the power reduction gear 30 being positioned below the power motor 20.

The power reduction gear 30 is a device for reducing a rotational speed from the power motor 20, and the power reduction gear 30 is a device for transmitting this rotation speed to a power output shaft 36b. The power reduction gear 30 includes a power planetary gear mechanism 31.

The power planetary gear mechanism 31 includes a power input shaft 32 connected to the output shaft 21 of the power motor 20.

A sun gear 33 is coaxially attached to the power input shaft 32. A plurality of planetary gears 34 is rotatably arranged on an outer peripheral side of the sun gear 33, the plurality of planetary gears 34 engaging with the sun gear 33.

An internal gear 35, with which each of the planetary gears 34 engage, is provided on the outside of the planetary gears 34, the internal gear 35 being fixed to the inside of the upper case 3.

A power side ring gear 37 is provided on an outer peripheral side of the internal gear 35.

A planetary carrier 36 is provided below the planetary gears 34, the planetary carrier 36 rotatably supporting the planetary gears 34. The planetary carrier 36 includes a planetary carrier support part 36a that extends downward. The planetary carrier support part 36a is rotatably supported by a bearing 75.

The planetary carrier support part 36a is formed in a substantially cylindrical shape with the inside being hollow, and the power output shaft 36b is connected to the planetary carrier support part 36a.

The output shaft 21 of the power motor 20, and the power output shaft 36b, are arranged so as to be respectively coaxial.

A lubrication oil pump 60 is supported by a lower part of the power planetary gear mechanism 31, the lubrication oil pump 60 pressure-feeds lubrication oil to the power input shaft 32.

The power output shaft 36b is housed inside the lower case 4, and a propeller shaft 11 is rotatably supported below the lower case 4, the propeller shaft 11 extending downward substantially orthogonal to the power output shaft 36b.

A gear mechanism 65 engages with a lower end part of the power output shaft 36b, the gear mechanism 65 changing a rotation direction of the power output shaft 36b to a substantially orthogonal direction, and the gear mechanism 65 transmitting this rotation direction to the propeller shaft 11.

The gear mechanism 65 is composed of a power shaft side bevel gear 66 attached to the power output shaft 36b, and a propeller shaft side bevel gear 67 attached to the propeller shaft 11, the propeller shaft side bevel gear 67 engaging with the power shaft side bevel gear 66.

A rear end part of the propeller shaft 11 protrudes outward from a rear part of the lower case 4.

A propeller 10 is attached to the portion of the propeller shaft 11 that protrudes outward.

The propeller 10 is composed of a propeller support part 10a supported by the propeller shaft 11, a propeller case 10b that covers the propeller shaft 11, and a plurality of fins 10c provided on an outer peripheral surface of the propeller case 10b.

A steering fin 4a is integrally provided on a lower end part of the lower case 4, the steering fin 4a extending diagonally downward.

A steering reduction gear 50 includes a steering motor 40 and a steering planetary gear mechanism 51. Note that, the steering planetary gear mechanism 51 corresponds to a lubrication target portion of the present invention.

In the steering planetary gear mechanism 51, a steering input shaft 52 arranged parallel to an axial direction of the power input shaft 32 of the power reduction gear 30, a sun gear 53 fixed to the steering input shaft 52, a plurality of planetary gears 54 engaging with the sun gear 53, and an internal gear 55 with which each of the planetary gears 54 engage, the internal gear 55 being fixed to the inside of the upper case 3, are provided.

A planetary carrier 56 is provided on the steering planetary gear mechanism 51, the planetary carrier 56 rotatably supporting the planetary gears 54.

The planetary carrier 56 includes a steering side ring gear 57 positioned on an outer peripheral side of the internal gear 55, the steering side ring gear 57 engaging with the power side ring gear 37.

A steering input gear 58 is attached to a lower end of the steering input shaft 52.

A steering motor 40 is arranged at the rear of the steering reduction gear 50. A rotating shaft 41 of the steering motor 40 is arranged substantially parallel to the steering input shaft 52 and a steering output shaft 56b. A steering output gear 42 is provided on a lower end of the rotating shaft 41 of the steering motor 40.

A support shaft 80 is provided between the steering motor 40 and the steering reduction gear 50, the support shaft 80 extending in an up-down direction, so that the support shaft 80 is substantially parallel to the rotating shaft 41, the steering input shaft 52, and the steering output shaft 56b of the steering motor 40 and the steering reduction gear 50. A transmission gear 81 is provided below the support shaft 80, the transmission gear 81 respectively engaging with the steering output gear 42 and the steering input gear 58.

Also, by having the steering output gear 42, the transmission gear 81, and the steering input gear 58 engage with one another, power from the steering motor 40 is transmitted to the steering input shaft 52 of the steering reduction gear 50 through the transmission gear 81.

By having the planetary gears 54 rotate through the sun gear 53, by rotation of the steering input shaft 52, the planetary carrier 56 rotates, and along with this, the steering side ring gear 57 rotates.

When the steering side ring gear 57 rotates, the steering side ring gear 57 moves along the power side ring gear 37, and as a result of this, the lower case 4 rotates in a left-right direction with respect to the upper case 3. By having the steering fin 4a rotate by rotation of the lower case 4, steering of the outboard motor 1 is performed.

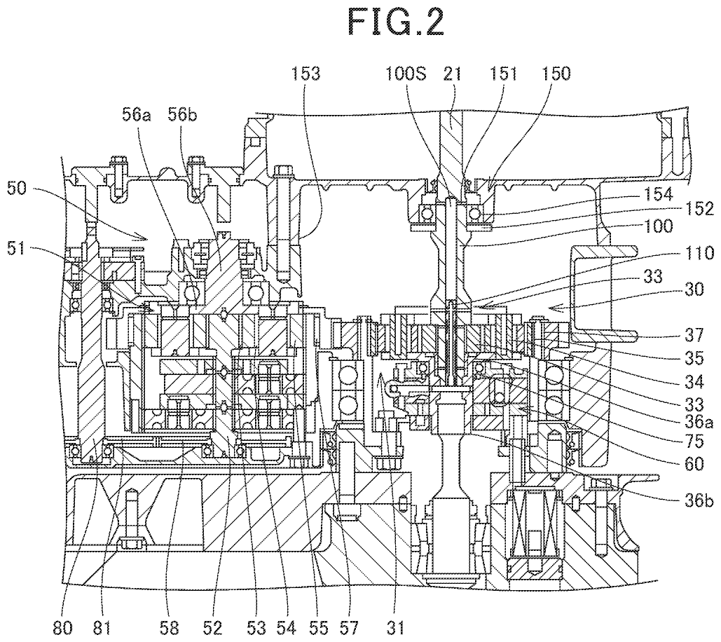

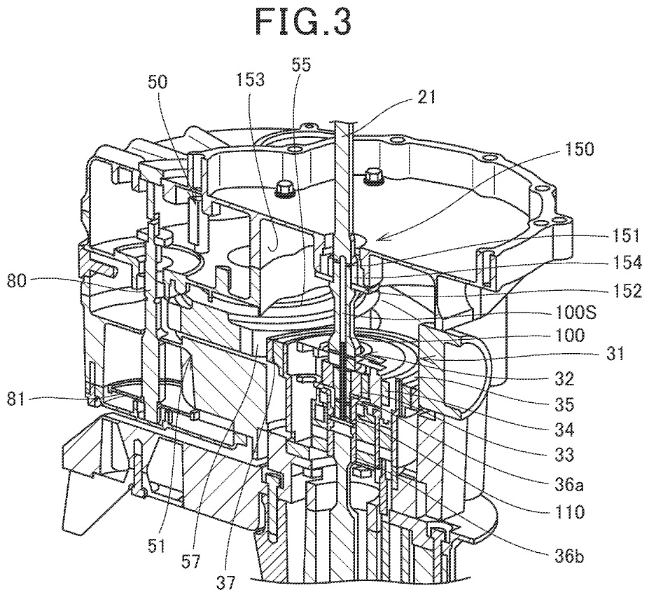

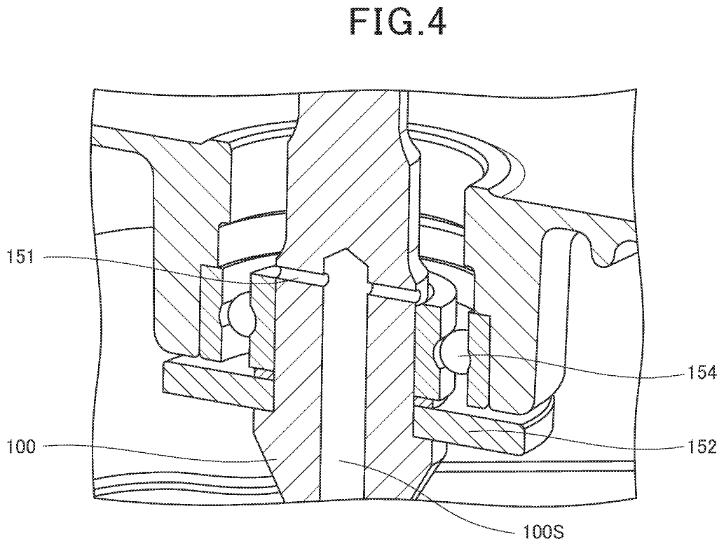

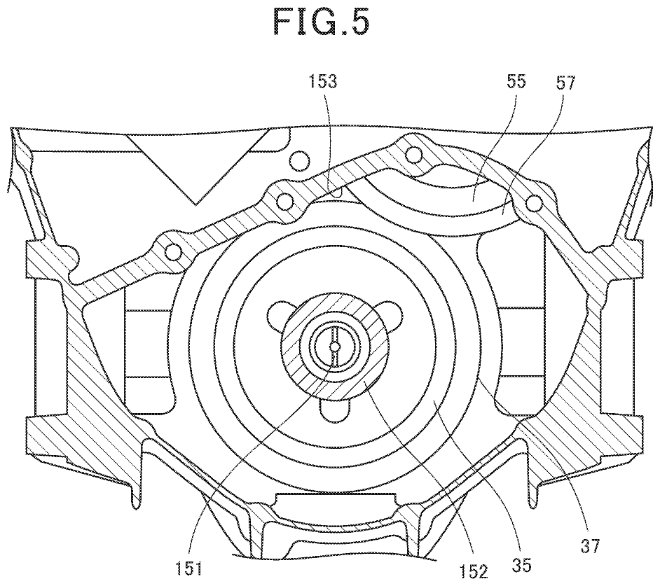

Next, a lubrication structure of the power reduction gear will be described. FIG. 2 is a side view of the power reduction gear and the steering reduction gear. FIG. 3 is a perspective view of the power reduction gear and the steering reduction gear. FIG. 4 is a perspective view of a rotary lubrication mechanism. FIG. 5 is a top view of the rotary lubrication mechanism.

As shown in FIG. 2, the power input shaft 32 of the power planetary gear mechanism 31 is composed of an external member 100 and an internal member 110 disposed on the inside the external member 100.

The external member 100 and the internal member 110 are cylindrical shaped members with a center being hollow. The internal member 110 is arranged by press-fitting or the like in a hollow part 100S of the external member 100. In the present embodiment, the external member 100, for example, is made of a carburized material or the like. In the present embodiment, the internal member 110, for example, is made of aluminum or carbon steel with a lower hardness than the external member 100.

A lubrication oil pump is provided on an outer peripheral side of the planetary carrier support part 36a.

The lubrication oil pump pumps up lubrication oil stored in the body case 2, and the lubrication oil pump supplies this lubrication oil to a lower end part of the internal member 110.

The hollow part 100S of the external member 100 and the inside of the internal member 110 communicate with one another.

A rotary lubrication mechanism 150 is provided on an upper part of the power input shaft 32. The rotary lubrication mechanism 150 includes a lubrication oil passage 151 extending in a radial direction, the lubrication oil passage 151 opened above the bearing 154, and the rotary lubrication mechanism 150 includes a lubrication oil auxiliary plate 152 arranged below the bearing 154.

The lubrication oil auxiliary plate 152 is an annular shaped member.

A lubrication oil reception wall 153 is provided on a side of the lubrication oil auxiliary plate 152.

The planetary gears 54 of the steering reduction gear 50 are provided below the lubrication oil reception wall 153. The lubrication oil reception wall 153 and the planetary gears 54 are arranged so that the end parts overlap, when seen from above. A cavity is provided on the inside of the planetary gears 54 in a radial direction, and this cavity fulfills the role of an oil reservoir.

Also, by rotating the power input shaft 32, lubrication oil discharged from the lubrication oil passage 151 by a centrifugal force is scattered in a radial direction, by a rotational force of the lubrication oil auxiliary plate 152.

Lubrication oil scattered in a radial direction attaches to the lubrication oil reception wall 153, and by having lubrication oil drip downward from the lubrication oil reception wall 153, lubrication oil can be supplied to the planetary gear 54 portion of the steering input shaft 52.

In this case, in the present embodiment, the lubrication oil reception wall 153 extends to below the lubrication oil auxiliary plate 152. In this way, in the case where a rotational speed of the power input shaft 32 is slow, and there is no scattering distance of lubrication oil, lubrication oil can be received by the lubrication oil reception wall 153.

Next, an action of the present embodiment will be described.

First, when the power motor 20 starts, the output shaft 21 of the power motor 20 rotates, and the power input shaft 32 connected to the output shaft 21 rotates. The power input shaft 32 transmits power to the sun gear 33 within the power reduction gear 30, the sun gear 33 being one part of the planetary gear mechanism 31. In this way, power is transmitted to the plurality of planetary gears 34 engaging with the sun gear 33, and this power causes the planetary gears 34 to rotate. By having the planetary gears 34 rotate, the planetary carrier 36 supporting the planetary gears 34 rotates, and power is transmitted to the power output shaft 36b. Power transmitted from the power output shaft 36b is converted into a rotation of a front-rear direction, through the gear mechanism 65, and power is transmitted to the propeller shaft 11. By having the propeller shaft 11 rotate, the propeller 10 supported by the propeller shaft 11 also rotates. According to this, a propulsive force is provided to a ship hull to which the outboard motor 1 is attached, and the ship hull moves forward.

Next, a supply operation of lubrication oil will be described.

First, when the lubrication oil pump 60 is operated, pressure-feeding of lubrication oil starts. Lubrication oil is pressure-fed by the lubrication oil pump 60, and this lubrication oil is sent to the power output shaft 36b of the power reduction gear 30. Lubrication oil passing through the inside of the power output shaft 36b is sent to the inside of the power input shaft 32.

Lubrication oil that has risen inside the power input shaft 32 is discharged from the lubrication oil passage 151, and this lubrication oil is supplied to the bearing 154 supporting the power input shaft 32.

Lubrication oil passing through the bearing 154 drips downward from the bearing 154, and this lubrication oil drips to the lubrication oil auxiliary plate 152 supported by the power input shaft 32. Lubrication oil dripping to the lubrication oil auxiliary plate 152 is scattered in a radial direction, by a centrifugal force by rotation of the power input shaft 32. Lubrication oil scattered in a radial direction is scattered to the lubrication oil reception wall 153 on the side of the lubrication oil auxiliary plate 152, the lubrication oil reception wall 153 being separately set. The lubrication oil received the lubrication oil reception wall 153 drips to the lower planetary gears 54 below the lubrication oil reception wall 153 and an oil reservoir of the planetary gear 54 groove part, by its own weight.

In this way, lubrication oil can be supplied to the planetary gear 54 portion of the steering planetary gear mechanism 51.

Note that, lubrication oil is stored in a lower part of the steering planetary gear mechanism 51. Accordingly, since stored lubrication oil is scraped up, along with the rotation driving of the steering planetary gear mechanism 51, lubrication can be performed by this stored lubrication oil.

As stated above, in the outboard motor 1 of the present embodiment, in the outboard motor 1 having a power motor 20 and a power reduction gear 30, the output shaft 21 of the power motor 20 is connected to the power input shaft 32 of the power reduction gear 30, the power input shaft 32 is a cylindrical shaped member, a lubrication oil auxiliary plate 152 is provided on the power input shaft 32, and a lubrication oil passage 151 to the lubrication oil auxiliary plate 152 is formed, from a center of the power input shaft 32.

According to this configuration, by supplying lubrication oil to the lubrication oil auxiliary plate 152, lubrication oil can be scattered by a centrifugal force, and lubrication oil can be supplied to distant members.

In the outboard motor 1 of the present embodiment, the lubrication oil auxiliary plate 152 is provided below a lubrication oil discharge port of the lubrication oil passage 151.

According to this configuration, by placing lubrication oil on the lubrication oil auxiliary plate 152, lubrication oil can be scattered far away by a centrifugal force.

In the outboard motor 1 of the present embodiment, the lubrication oil reception wall 153 is provided on a side of the lubrication oil auxiliary plate 152.

According to this configuration, by providing the lubrication oil reception wall 153, lubrication oil scattered from the lubrication oil auxiliary plate 152 can be stopped at a prescribed position.

In the outboard motor 1 of the present embodiment, the lubrication oil reception wall 153 overlaps with an end part of any of the gears 53, 54, 55, 57 mounted inside the outboard motor 1, when seen from above.

According to this configuration, by providing the gears 53, 54, 55, 57 below the lubrication oil reception wall 153, the gears 53, 54, 55, 57 requiring lubrication, lubrication oil attached to the lubrication oil reception wall 153 can drip by its weight and gravity, and lubrication oil can be supplied to the gears 53, 54, 55, 57.

In the outboard motor 1 of the present embodiment, the lubrication oil reception wall 153 overlaps with an oil reservoir, when seen from above.

According to this configuration, surplus lubrication oil can be stored, by an oil reservoir.

### Other Embodiments

The above-stated embodiment simply shows one aspect of the present invention, and the above-stated embodiment can be arbitrarily modified and applied in a range that does not deviate from the content of the present invention.

The upper case 3 and the lower case 4 may be respectively made of the same material, or the upper case 3 and the lower case 4 may be respectively made of different materials.

In the present embodiment, the body case 2 is provided separately from the upper case 3 and the lower case 4. However, the shape of the body case 2 is not limited to this. Namely, the upper case 3 and the lower case 4 may be integrated, or the upper case 3 and the lower case 4 may be formed by combining a plurality of components.

In the present embodiment, a carburized material is used for the external member 100, and aluminum or carbon steel is used for the internal member 110. However, the material of the external member 100 and the material of the internal member 110 are not limited, if a prescribed strength can be obtained.

The above embodiments support the following configurations.

(Configuration 1) A rotating shaft is formed in a hollow shape with lubrication oil conducted inside, a lubrication oil auxiliary plate is provided on the rotating shaft, and a lubrication oil passage to the lubrication oil auxiliary plate is formed from a center of the rotating shaft.

According to this configuration, by supplying lubrication oil to the lubrication oil auxiliary plate, lubrication oil can be scattered by a centrifugal force, and lubrication oil can be supplied to distant members.

(Configuration 2) The lubrication mechanism described in Configuration 1, in which the lubrication oil auxiliary plate is provided below a lubrication oil discharge port of the lubrication oil passage.

According to this configuration, by placing lubrication oil on the lubrication oil auxiliary plate, lubrication oil can be scattered far away by a centrifugal force.

(Configuration 3) The lubrication mechanism described in Configuration 2, in which a lubrication oil reception wall is provided on a side of the lubrication oil auxiliary plate.

According to this configuration, by providing the lubrication oil reception wall, lubrication oil scattered from the lubrication oil auxiliary plate can be stopped at a prescribed position.

(Configuration 4) The lubrication mechanism described in Configuration 3, in which the lubrication oil reception wall overlaps with a lubrication target portion when seen from above.

According to this configuration, by providing portions requiring lubrication below the lubrication oil reception wall, lubrication oil attached to the lubrication oil reception wall can drip by its weight and gravity, and lubrication oil can be supplied to a target portion.

(Configuration 5) The lubrication mechanism described in Configuration 4, in which the lubrication oil reception wall overlaps with an oil reservoir of a device on which a rotating shaft is mounted, when seen from above.

According to this configuration, surplus lubrication oil can be stored, by an oil reservoir.

### REFERENCE SIGNS LIST

1 outboard motor
2 body case
3 upper case
4 lower case
4a steering fin
10 propeller
10a propeller support part
10b propeller case
10c fin
11 propeller shaft
20 power motor
21 output shaft
30 power reduction gear
31 power planetary gear mechanism
32 power input shaft
33 sun gear
34 planetary gear
35 internal gear
36 planetary carrier
36a planetary carrier support part
36b power output shaft
37 power side ring gear
40 steering motor
41 rotating shaft
42 steering output gear
50 steering reduction gear
51 steering planetary gear mechanism
52 steering input shaft
53 sun gear
54 planetary gear
55 internal gear
56 planetary carrier
56b steering output shaft
57 steering side ring gear
58 steering input gear
60 lubrication oil pump
65 gear mechanism
66 power shaft side bevel gear
67 propeller shaft side bevel gear
75 bearing
80 support shaft
81 transmission gear
100 external member
100S hollow part
110 internal member
150 rotary lubrication mechanism
151 lubrication oil passage
152 lubrication oil auxiliary plate
153 lubrication oil reception wall
154 bearing

1. A lubrication mechanism, wherein
a rotating shaft is formed in a hollow shape with lubrication oil conducted inside,
a lubrication oil auxiliary plate is provided on the rotating shaft,
a lubrication oil passage to the lubrication oil auxiliary plate is formed from a center of the rotating shaft, and
a bearing is provided between the lubrication oil passage and the lubrication oil auxiliary plate.

2. The lubrication mechanism according to claim 1, wherein the lubrication oil auxiliary plate is provided below a lubrication oil discharge port of the lubrication oil passage.

3. The lubrication mechanism according to claim 2, wherein a lubrication oil reception wall is provided on a side of the lubrication oil auxiliary plate.

4. The lubrication mechanism according to claim 3, wherein the lubrication oil reception wall overlaps with a lubrication target portion when seen from above.

5. The lubrication mechanism according to claim 4, wherein the lubrication oil reception wall overlaps with an oil reservoir of a device on which the rotating shaft is mounted, when seen from above.
